(19) United States
(12) Patent Application Publication
(10) Pub. No.: US 2016/0084392 A1
(43) Pub. Date: Mar. 24, 2016

(54) Dual Flow Check Valve

(71) Applicant: Ben Horton, Smithville, TX (US)

(72) Inventor: Ben Horton, Smithville, TX (US)

(21) Appl. No.: 14/859,660

(22) Filed: Sep. 21, 2015

Related U.S. Application Data
(60) Provisional application No. 62/052,566, filed on Sep. 19, 2014.

(51) Int. Cl. F16K 15/03; G05D 16/14; F16K 31/12

(52) U.S. Cl. CPC F16K 15/03; F16K 31/12; G05D 16/14

(57) ABSTRACT

A dual flow check valve having a check valve body with an interior chamber. There is a first inlet in open communication with the chamber and a second inlet in open communication with the chamber. There is also an outlet in open communication with the chamber. A pressure responsive valve element to permit one-way flow of a fluid through the first inlet into the chamber is mounted in the body.

### CROSS REFERENCE TO RELATED APPLICATION

This application claims priority to U.S. Application No. 62/052,566 filed on Sep. 19, 2014, the disclosure of which is incorporated herein by reference for all purposes.

### FIELD OF THE INVENTION

The present invention relates to check valves and, more particularly, to check valves that can be used in systems to accommodate dual flow of low and high pressure fluids.

### BACKGROUND OF THE INVENTION

A typical check valve is a valve that only allows fluid (liquid or gas) to flow in only one direction. Prior art check valves generally are two-port valves, i.e., they have two openings in the valve body, one for fluid to enter and one for fluid to leave.

There are many systems, industrial processes, and the like, wherein the flow of both high pressure and low pressure fluids are involved. A primary example of this is hydrostatic testing. A hydrostatic test is used to check pressure vessels such as pipes, pipelines, gas cylinders, boilers, etc. for strength and leaks. Typically, the test involves filling the pressure vessel, e.g., the pipe, with a liquid, usually water, which can be dyed to aid in visual leak detection, followed by pressurization of the pressure vessel to the specified test pressure.

In particular, hydrostatic testing is commonly employed in the oil and gas industry to test piping such as casing, tubing, etc. used in downhole operations as well as other pressure vessels and equipment, e.g., BOP testing, which are used in the drilling, completion, and production from oil and gas wells. In oil and gas well operations, time is money. Accordingly, there is a continual effort to reduce the amount of time a given procedure takes. One prior art method of conducting hydrostatic testing in oilfield operations involves the use of a high pressure, low flow rate (HPLFLO) pump, such as a positive displacement pump to fill the pressure vessel and, once filled, to continue to pressurize the vessel to the desired test pressure. Generally, this procedure is time consuming since the pump output is low.

It will be recognized that while there are high pressure, high flow rate pumps available, their use in hydrostatic pressure testing poses a potentially serious problem, since once the pressure vessel is filled, because the pumps operate at a high pressure and high flow rate, the desired test pressure can be easily exceeded, possibly rupturing the pressure vessel.

### SUMMARY OF THE INVENTION

In one aspect, the present invention provides a check valve that can have dual flow of fluid into and out of the valve.

In another aspect, the present invention provides a check valve having a first inlet for connection to a high pressure source, a second inlet for connection to a low pressure source, and an outlet.

In a further aspect, the present invention provides a system for conducting hydrostatic testing comprising the check valve of the present invention, a source of low pressure, high flow rate liquid connected to the check valve, and a source of high pressure, low flow rate liquid connected to the check valve.

In still a further aspect, the present invention provides a system for use in downhole operations, e.g., chemical injection, wherein, a chemical composition can be injected into the borehole to a desired fill volume using a low pressure, high volume pumping apparatus, following which a high pressure, low volume pump connected to the check valve can be used to pressurize the chemical composition and force it into the formation, etc.

These and further features and advantages of the present invention will become apparent from the following detailed description, wherein reference is made to the figures in the accompanying drawings.

### BRIEF DESCRIPTION OF THE DRAWINGS

FIG. 1 is an elevational, cross-sectional view showing the check valve of the present invention connected to a low pressure, high flow rate (LPHFLO) pump which is in operation and the valve element open.

FIG. 2 is a view similar to FIG. 1 but with the valve element closed and the valve being connected to a HPLFLO pump, e.g., a positive displacement pump.

FIG. 3 is a schematic representation of a system for testing a pressure receptor using the check valve of the present invention.

### DETAILED DESCRIPTION OF PREFERRED EMBODIMENTS

Although reference is made to a “fluid” throughout the following description, it will be understood that in most cases, the fluid will be a liquid, particularly in the case of oilfield applications where the high pressures necessary can generally not be easily achieved with gases.

As used herein, the term “pressure receptor” refers to any vessel, pipe, container, or formation which can be pressurized to a desired level and includes, without limitation, pipes, pressure vessels, boreholes, downhole formations in communication with boreholes, and the like.

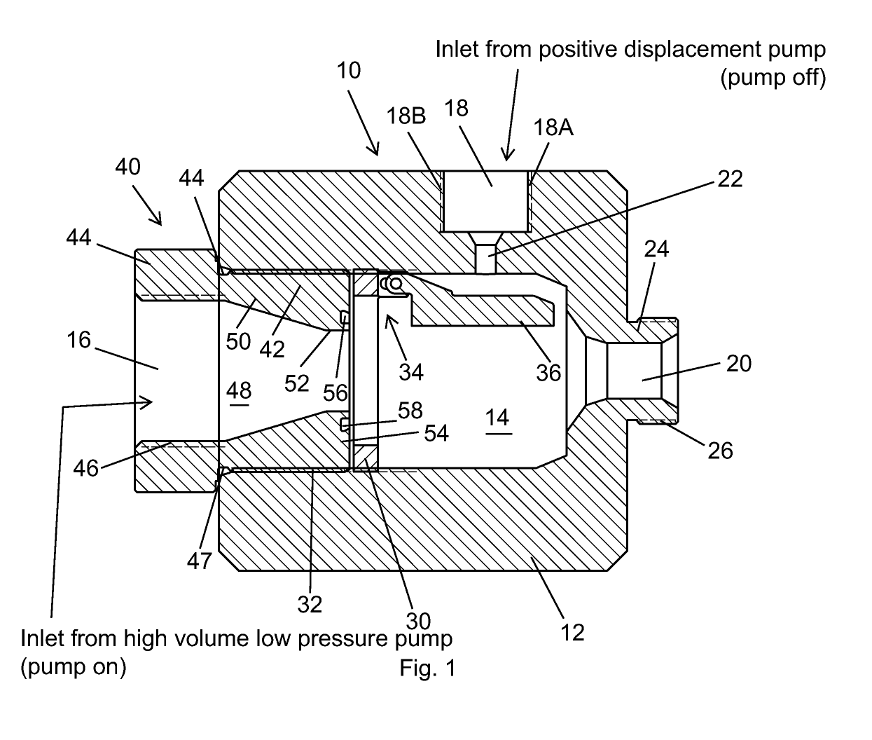

Referring first to FIG. 1, the valve shown generally as 10 comprises a valve body 12 having an internal cavity or chamber 14. The valve body 12 has a first inlet 16, a second inlet 18, and an outlet 20. Inlet 18 is counterbored and has a larger diameter section 18A with internal threads 18B and a smaller diameter section 22 opening into chamber 14. Outlet 20 is formed by a nipple 24, integral with body 12, and being externally threaded as at 26.

Inlet 16 comprises an externally threaded ring 30 threadedly received in a threaded opening 32 in valve body 12 in open communication with chamber 14. Ring 30 carries one part of a hinge assembly 34 by which ring 30 is hingedly connected to a disc shaped valve element 36 of the type used in a typical gravity operated, swing check valve.

Inlet 16 further comprises a fitting shown generally as 40 having a first body portion 42 which is externally threaded and is threadedly received in threaded opening 32, body portion 42 being connected to a flange portion 44, the O.D. of flange portion 44 being larger than the O.D. of body portion 42. Flange portion 44 is internally threaded as at 46. A seal 47 is disposed in a groove 49 in body 12 to form a seal between flange portion 44 and valve body 12. Body portion 42 has an opening 48 formed by a frustoconical surface 50 and a cylindrical surface 52. Body portion 42 also has a front surface 54 which has an annular groove 56 therein, an o-ring or similar seal 58 being received in groove 56.

In the configuration shown in FIG. 1 (the fill cycle), and with the system in operation, outlet 20 would be connected by a quick disconnect hose or the like to a pressure vessel (not shown) to be filled. The output of a low pressure, high volume (LPHFLO) pressure pump, e.g., a centrifugal pump, is connected by suitable plumbing to inlet 16, such that the test liquid flows through flange portion 44, body portion 42, and ring 30, into chamber 14, through outlet 20, and ultimately, into the pressure vessel. As seen in FIG. 1, valve element 36 would then be in the open position. It will also be appreciated that if a HPLFLO pump were connected to inlet 18, it would be in the off position and could have a valve (not shown) disposed between inlet 18 and that pump, ensuring the fluid flowing into inlet 16 would pass through outlet 20 and into the vessel to be pressurized.

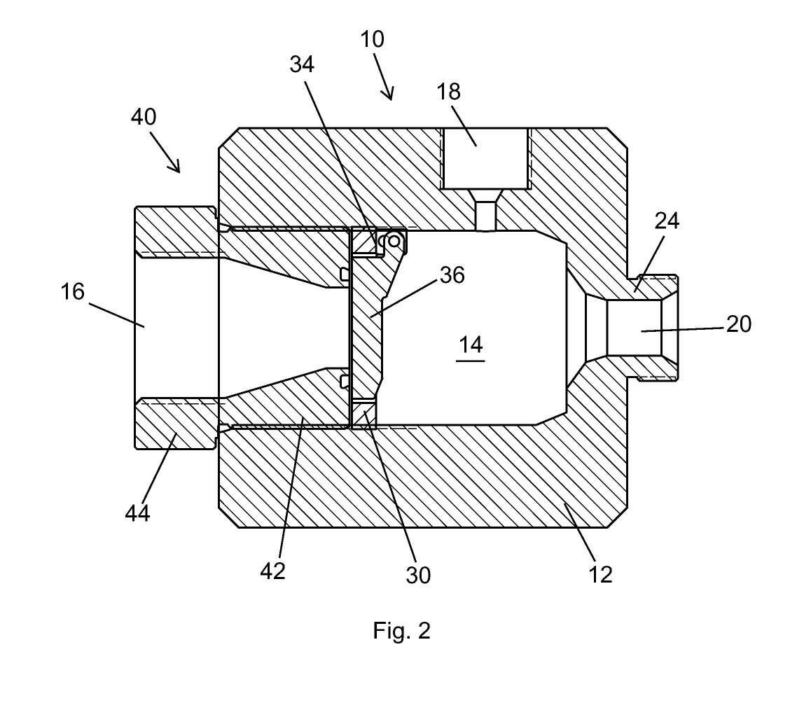

Turning now to FIG. 2, the valve is shown in a condition when the fill cycle shown in FIG. 1 has been completed, i.e., when the pressure vessel has been filled to the desired capacity. At this juncture, the fill pump, e.g., the LPHFLO pump is off, and any valve between the outlet of that pump and the inlet 16 is closed. Further, the HPLFLOW pump is now on, fluid from that pump entering valve cavity 14 through inlet 18, the high pressure liquid forcing valve element 36 into sealing engagement with seal ring 58 and preventing any flow of high pressure fluid out of inlet 16. Rather, the high pressure fluid, at a low flow rate, is forced through outlet 20 and into the pressure vessel until the desired test pressure is reached. At this point, as is well known to those skilled in the art, the HPLFLO pump can be turned off and the pressure vessel left in a static position for a desired period of time to determine if there are any leaks or other faulty conditions associated with the pressure vessel.

As can be seen from the above, the dual flow check valve of the present invention provides a quick and convenient way to conduct a pressure test on a pressure vessel by using the dual flow check valve to rapidly fill the pressure vessel and, once filled, to pressurize the pressure vessel to the desired test pressure.

While the check valve of the present invention as described above uses a gravity close swing type valve element, e.g. a flapper, it will be understood that other valve elements such as ball valve elements, cone valve elements, and the like may be used. However, whatever the type of valve element employed, if the dual flow valve of the present invention is to be used in a fill and pressure test, then it is desirable that the valve element be of a type which permits high flow rates. In this regard, ball valve elements, cone valve elements, or the like are more restrictive than swing type disc valves as shown. However, it will be appreciated that while the swing type check valve shown in the drawings and described above is gravity closed, a torsion spring well known to those skilled in the art could form part of the hinge assembly such that the valve was maintained in the normally closed position until there was flow from a source of high volume flow.

FIGS. 1 and 2 depict the typical scenario for a standard hydrostatic pressure test of a pressure vessel. It is to be understood that the LPHFLO pump can take many forms, including even a fire hydrant outlet. Thus, the valve of the present invention can be used at remote sites, e.g., oil and gas well sites without the need for a sophisticated high volume low pressure pump. Indeed, centrifugal pumps such as the type used in swimming pools, spas or the like can be employed. In general, any LPHFLO pump can be used. Non-limiting examples of LPHFLO pumps include positive displacement pumps such as diaphragm pumps, plunger pumps, progressive cavity pumps, and the like. Typically when used in oilfield applications, duplex and triplex pumps are generally available on site and can be employed.

It will be appreciated by those skilled in the art that the check valve of the present invention can employ high pressure and low pressure fluid sources that vary over wide limits. For example, in the case of the LPHFLO pump, if a pump is employed as opposed to another source of such fluid, the pumps can have pressure ratings ranging from about 20 to about 5,000 psi, usually ranging from about 300 to about 500 psi, and flow rates of from about 10 to about 1,000 gallons/minute, usually from about 60 to about 100 gallons/minute. Again, and by way of example only, if the HPLFLO is a pump as opposed to another source the pump can have pressure ratings of from 50 to 40,000 psi, usually from about 15,000 to about 20,000 psi, and flow rates of from about 2 to about 60 gallons/minute, usually from about 5 to about 10 gallons/minute. As a practical matter the maximum pressure from the HPLFLO source is limited by the burst pressure of valve body 12. In general, when a pressure receptor, e.g., a vessel, is being pressure tested, the highest pressure of the low pressure source will be lower than the lowest pressure of the high pressure source. Similarly, the highest flow rate of the low pressure source will be higher than the highest flow rate of the high pressure source. In certain cases, as for example, when a pressure testing is completed, it may be desirable to attach a vacuum pump to the second, high pressure inlet, to evacuate residual fluid left in the chamber of the valve body.

The dual flow check valve of the present invention can be used in a number of industrial applications but finds particular application in oil field operations. For example, in the case of chemical injection downhole, the valve can be connected to a LPHFLO pump to fill the volume to be filled with the desired amount of chemicals, after which, the HPLFLO pump would be employed to pressurize the chemical composition to force it into the formation or for other uses. The system of the present invention can also be used in hydraulic fracturing. In this regard, a given section of a wellbore to be fractured could be rapidly filled with fracturing fluid using the LPHFLO pump followed by using the HPLFLO pump which would force the fracturing fluid into the formation to cause fissures for allowing formation fluids to flow into the borehole for production. The dual flow valve and system of the present invention can be used in virtually any application where a system is needed which requires a high flow rate pump for fill purposes but a low flow rate, high pressure pump for pressurization purposes.

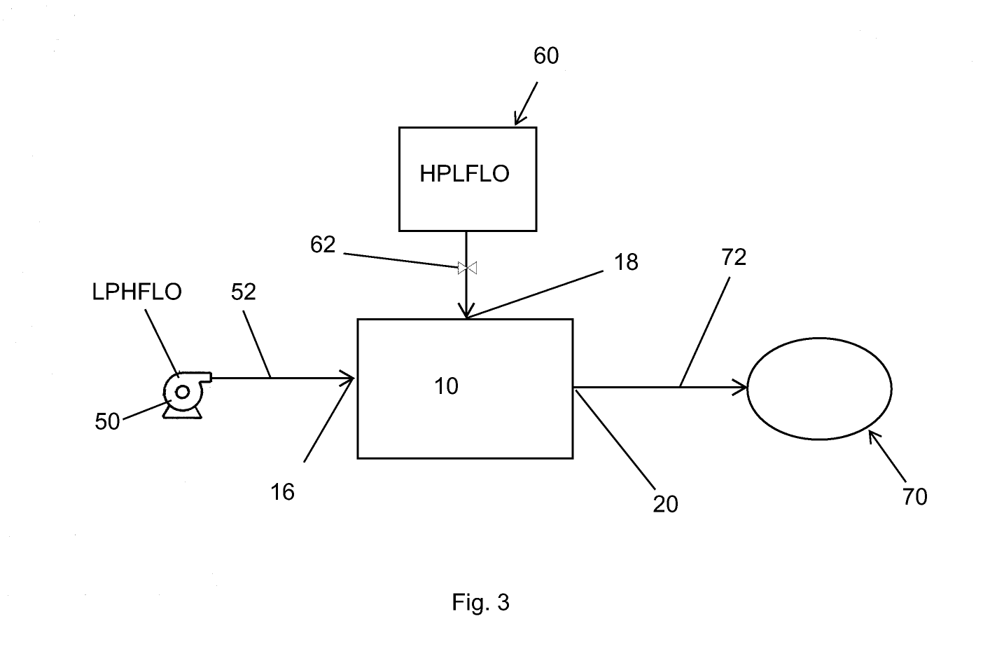

Reference is now made to FIG. 3 for a description of the system of the present invention employing the inventive check valve and a method of pressurizing a pressure receptor, e.g., a pressure vessel, to the desired pressure. Check valve 10 has its first inlet 16 connected to a low pressure, high flow rate pump 50 via connector 52. Connected to second inlet 18 via line 62 is a high pressure, low flow rate pump 60, there being a valve 63 between pump 60 and check valve 10 to control flow from pump 60 to check valve 10. Connected to the outlet 20 of check valve 10 via connector 72 is a pressure receptor 70 which, as noted above can be a variety of vessels, pipes or the like, as well as a downhole formation, e.g., a formation to be fractured. In operation, and at the commencement of the testing, pump 60 would be off. Fluid from a suitable source (not shown) would be introduced by pump 50 through inlet 16 into check valve 10 and ultimately through outlet 20 and through connector 72 into pressure vessel 70. This operation would continue until pressure vessel 70 had been filled to the desired volume.

Once pressure vessel 70 is filled to the desired volume, pump 50 would be turned off, valve 62 would be opened and pump 60 would be activated. Fluid from a suitable source (not shown) would be introduced by pump 60 through second inlet 18 into check valve 10 and flow into pressure vessel 70 through outlet 20 until the pressure in vessel 70 had reached the desired level. It will be understood that because of the swing check valve element in check valve 10, once flow from pump 50 ceases, the valve element will swing to the closed position, by gravity or by spring tension, if the hinge assembly 34 has a biasing element to move the disc to the closed position, and be maintained in that position by the pressure from pump 60 as it pressurizes pressure receptor 70 to the desired pressure.

Although specific embodiments of the invention have been described herein in some detail, this has been done solely for the purposes of explaining the various aspects of the invention, and is not intended to limit the scope of the invention as defined in the claims that follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A dual flow check valve, comprising:
a check valve body forming an interior chamber;
a first inlet in open communication with said chamber;
a second inlet in open communication with said chamber;
an outlet in open communication with said chamber; and
a pressure responsive valve element to permit one-way flow of a fluid through said first inlet into said chamber.

2. The check valve of claim 1, wherein said valve element is a swing check valve disc, said disc being movable between a first position wherein said first inlet is opened and a second position wherein said first inlet is closed.

3. The check valve of claim 2, wherein there is a hinge interconnecting said disc and a disc valve mount in said body.

4. The check valve of claim 3, wherein said mount comprises a ring threadedly received in said body proximate said first inlet.

5. The check valve of claim 2, wherein there is a fitting, threadedly received in said first inlet.

6. The check valve of claim 5, wherein said fitting is adapted to be connected to a source of fluid.

7. The check valve of claim 6, wherein said fitting has an annular surface facing said chamber and there is an annular seal on said surface, said annular seal being engageable by said disc when said disc is in said second position.

8. The check valve of claim 7, wherein there is an annular groove in said surface and said seal comprises an o-ring received in said annular groove.

9. The check valve of claim 2, wherein said disc is normally biased to said second position.

10. A system for pressurizing a fluid pressure receptor, comprising:
the dual flow check valve of claim 1;
a high flow rate, low pressure source operably connected to said first inlet;
a low flow rate, high pressure source operably connected to said second inlet; and
a receptor for receiving fluid at an elevated pressure operatively connected to said outlet.

11. A method of pressurizing a pressure receptor comprising:
providing the valve body of claim 1;
providing a pressure receptor;
connecting said pressure receptor to said outlet;
providing a source of a first fluid at a low pressure and high flow rate to said first inlet;
introducing said first fluid into said first inlet until the volume of said fluid in said receptor reaches a first desired level;
discontinuing flow of said first fluid when said desired volume level in said pressure receptor is achieved;
providing a source of a second fluid at a high pressure and low flow rate to said second inlet;
introducing said second fluid into said second inlet until the pressure in said pressure receptor reaches a desired value, wherein the pressure of said first fluid is lower than the lowest pressure of said second fluid and the flow rate of said first fluid is higher than the highest flow rate of said second fluid.
